(19) United States
(12) Patent Application Publication
(10) Pub. No.: US 2004/0151218 A1
(43) Pub. Date: Aug. 5, 2004

(54) Systems and methods for tremor cancellation in pointers

(76) Inventors: Vlad Branzoi, New York, NY (US); Shree Nayar, New York, NY (US)

Correspondence Address: WILMER CUTLER PICKERING HALE AND DORR LLP, 300 PARK AVENUE, NEW YORK, NY, 10022, US

(21) Appl. No.: 10/744,431

(22) Filed: Dec. 22, 2003

Related U.S. Application Data
(60) Provisional application No. 60/436,076, filed on Dec. 23, 2002.

(51) Int. Cl. H01S 3/10

(52) U.S. Cl. 372/25

(57) ABSTRACT

Systems and methods for detecting a raw position on a surface pointed to by a user, observing motion in the raw position, filtering that motion to reduce perceived tremor, and presenting a marker on a surface at a smoothed position with the filtered motion are provided. Certain embodiments may include an infrared laser pointer, a position sensitive detector, a visible laser pointer, and a control system. Other embodiments may use a combined detector/highlighter, a combined detector/pointer, a registration mechanism, a projected marker, a separate pointing surface, a pointer that transmits mouse clicks, a pointer that modulates a laser to indicate mouse clicks, and/or a laser pointer with built-in tremor control. Any suitable filtering technique may be used to filter the detected tremor, including band pass filters, Kalman filters, and linear equalization filters.

### CROSS REFERENCE TO RELATED APPLICATION

This application claims the benefit of U.S. Provisional Patent Application No. 60/436,076, filed Dec. 23, 2002, which is hereby incorporated by reference herein in its entirety.

### FIELD OF THE INVENTION

Generally speaking, the present invention relates to systems and methods that cancel tremor in pointers. More particularly, the present invention relates to systems and methods that cancel the appearance of tremor in pointers by detecting movement of a pointer relative to a target, filtering the detected movement, and projecting a marker at the target with the filtered movement.

### BACKGROUND OF THE INVENTION

In meeting rooms around the world, laser pointers are an essential part of almost every presentation. With the advent of laser diodes, pen-sized lasers have become cheap enough and small enough that these devices have replaced the telescoping and wooden, stick-like pointers that were commonly used by speakers giving presentations and/or lectures in the past. Prior to this point, speakers were required to stand relatively close, usually only a few feet away, from the surface on which presentations were being given. For example, with an overhead projection, a speaker would usually stand next to the screen on which the projection was being made and place the distal end of a pointer on or just above the surface of the screen on which a desired item was being projected.

Today, using a pen-sized laser pointer, speakers are able to stand at much greater distances away from the surface on which a presentation is being given while still being able to very clearly indicate desired portions of the presentation due to the bright and pin-point aspects of laser beams. For example, a speaker now has the ability to stand at the very back of an auditorium and clearly mark a surface at the front of the auditorium with a laser beam having the size of a pencil eraser.

Unfortunately, as a speaker gets further and further from a surface on which he is trying to mark an item, it becomes increasingly difficult to hold the marker created by the laser pointer steady. This is due at least in part to the natural hand tremor that every human has. The magnitude of the tremor is influenced by a variety of factors such as age, medical condition (e.g., Parkinson's disease), adrenaline, nervousness, tiredness, and drugs (e.g., caffeine). As hand tremor causes vibrations in a speaker's hand, a pen-sized laser pointer is unwillingly moved at small angles away from the intended direction. As the distance from the pointer to the marked surface increases, so too does the distance between the intended point and the point at which the laser beam is shown on the surface.

Accordingly, it is desirable to reduce the effects of tremor that are present in the appearance of laser pointers.

### SUMMARY OF THE INVENTION

The present invention provides systems and methods for tremor cancellation in pointers. In accordance with the invention, the systems and methods detect a raw position on a surface pointed to by a user, observe motion in the raw position, filter that motion to reduce perceived tremor, and present a marker on a surface at a smoothed position with the filtered motion. Certain embodiments may include an infrared laser pointer, a position sensitive detector, a visible laser pointer, and a control system. Other embodiments may use a combined detector/highlighter, a combined detector/pointer, a registration mechanism, a projected marker, a separate pointing surface, a pointer that transmits mouse clicks, a pointer that modulates a laser to indicate mouse clicks, and/or a laser pointer with built-in tremor control. Any suitable filtering technique may be used to filter the detected tremor, including band pass filters, Kalman filters, and linear equalization filters.

In accordance with an embodiment of the invention, a system for canceling pointer tremor of a user features a detector, a control system, and a highlighter. The detector generates raw position signals representative of positions on a pointing surface pointed to by the user. The control system is coupled to the detector, receives the raw position signals from the detector, filters motion detected in the raw position signals to produce smoothed position signals, and produces a control signal representative of the position of the smoothed position signals. The highlighter is coupled to the control system, receives the control signal, and causes a marker to be presented on a display surface in response to the control signal.

In accordance with another embodiment of the invention, a laser pointer features a laser source that generates a laser beam, a detector that detects a reflection of the laser beam and at least one other feature of a display surface, a controllable mirror that controls a direction in which the laser source and the detector are pointing, and a processor that detects motion in the reflection relative to the at least one other feature, that filters the motion, and that controls the controllable mirror to reduce tremor in the laser beam.

In accordance with yet another embodiment of the invention, a method for canceling pointer tremor of a user features detecting raw positions on a pointing surface pointed to by the user, filtering motion detected in the raw positions to produce smoothed positions, and causing a marker to be presented on a display surface at the smoothed positions.

### BRIEF DESCRIPTION OF THE DRAWINGS

The present invention is described below in further detail in conjunction with the accompanying drawings, in which like reference characters refer to like parts throughout, and in which:

FIG. 1 shows a block diagram of one embodiment of hardware in accordance with the present invention;

FIG. 2 shows a flow diagram of a one embodiment of a control system process in accordance with the present invention;

FIG. 3 shows a block diagram of another embodiment of hardware using a combined detector/highlighter in accordance with the present invention;

FIG. 4 shows a block diagram of another embodiment of hardware using a combined detector/pointer in accordance with the present invention;

FIG. 5 shows a block diagram of another embodiment of hardware using a registration mechanism in accordance with the present invention;

FIG. 6 shows a block diagram of another embodiment of hardware in which a marker is projected in accordance with the present invention;

FIG. 7 shows a block diagram of another embodiment of hardware in which a separate pointing surface is used in accordance with the present invention;

FIG. 8 shows a block diagram of one embodiment of a laser pointer including a transmitter in accordance with the present invention;

FIG. 9 shows a block diagram of another embodiment of hardware including a modulator in accordance with the present invention;

FIG. 10 shows a block diagram of one embodiment of a combined detector/highlighter in accordance with the present invention;

FIG. 11 shows a block diagram of one embodiment of a laser pointer including a built-in tremor control in accordance with the present invention;

FIG. 12 shows a flow diagram of one embodiment of a band pass filter in accordance with the present invention;

FIG. 13 shows a block diagram one embodiment of a setup process in accordance with the present invention;

FIG. 14 shows a block diagram of one embodiment of a Kalman filter in accordance with the present invention;

FIG. 15 shows a flow diagram of one embodiment of a Kalman filter in accordance with the present invention;

FIG. 16 shows a block diagram of one embodiment of a tracking test in accordance with the present invention;

FIG. 17 shows a block diagram of one embodiment of Filtered Mean Square Error with delay correction calculation in accordance with the present invention;

### DESCRIPTION OF PARTICULAR EMBODIMENTS OF THE INVENTION

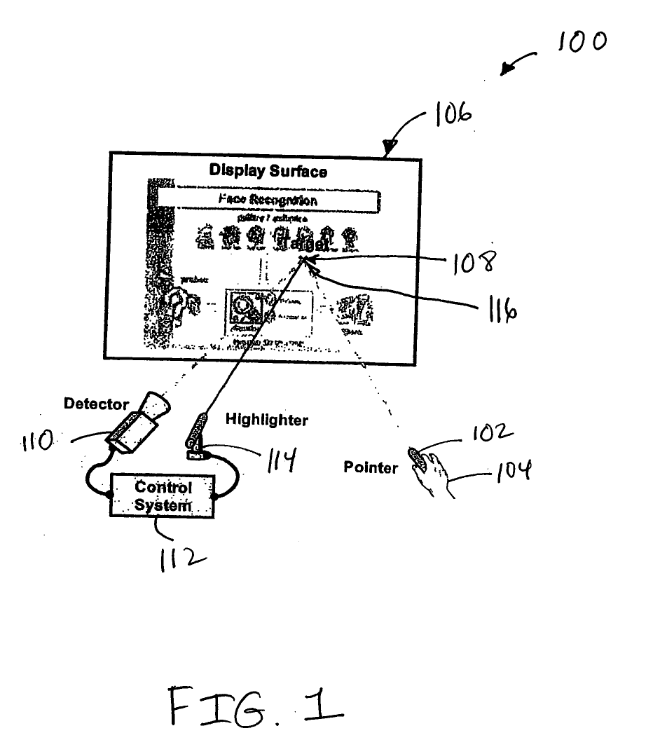

Turning first to FIG. 1, a system 100 in accordance with one embodiment of the present invention is illustrated. As shown, system 100 includes a pointer 102 that is held in the hand 104 of a user and aimed at a target point 108 on a display surface 106. Preferably, pointer 102 is a low-power (e.g., less than 10 mW) infrared laser pointer (e.g., with a wavelength of 800-1000 nm), although any suitable mechanism for invisibly identifying target point 108 on surface 106 may be used. Pointer 102 creates an illumination 116 on surface 106. System 100 also includes a detector 110 that is used to detect the location of illumination 116, and hence target point 108, on surface 106. Detector 110 is preferably a two-dimensional position sensitive detector (PSD), such as one of those available from Hamamatsu Corporation, Bridgewater, N.J., with an infrared passing filter, although a camera or any other suitable detection device may also be used. As illustrated, the output of detector 110 is connected to a control system 112. Control system 112 determines the location of illumination 116 on surface 106, filters out tremors detected in illumination 116, and aims a highlighter 114 at target point 108 to create a reduced-tremor marker thereon. Control system 112 may be any suitable combination of hardware and/or software for determining the location of illumination 116 on surface 106, filtering out tremor detected in illumination 116, and aiming highlighter 114 at target point 108. Highlighter 114 may be any suitable controllable pointing device, such as a laser pointer, or other light source, pointed toward a mirror that may be controllably move on a two-axis gimbal. Although detector and highlighter 114 are shown connected to control system 112, it should be apparent that these devices, as well as other devices described herein, may be indirectly, directly, or wirelessly coupled in any suitable fashion.

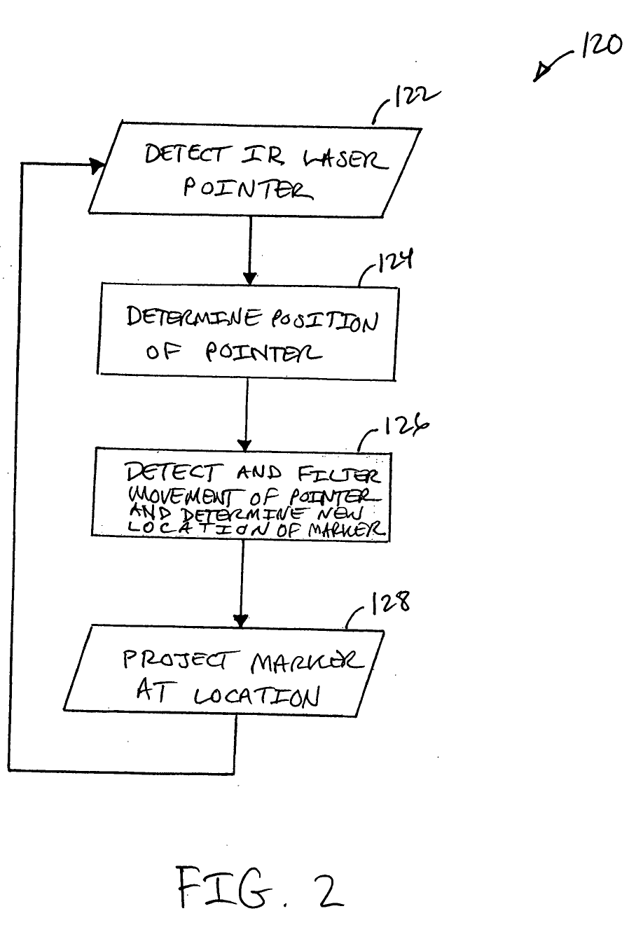

FIG. 2 illustrates a process 120 that may be executed in control system 112 in accordance with one embodiment of the invention. As shown, at step 122, process 120 detects illumination 116 from infrared laser pointer 102. Next, at step 124, the process determines the raw position, r(t), of pointer 102 on surface 106. This may be accomplished based upon a comparison of the detected illumination to the predetermined geometry of detector 110 with respect to surface 106, or based upon a comparison of the detected illumination to other detected features displayed on surface 106. Process 120 may then detect and filter movement of illumination 116 and determine the smoothed location, s(t), of the marker at step 126. In accordance with the invention, step 126, in filtering the movement of illumination 116, may use any of a number of known filtering techniques to reduce tremor that is detected in the illumination. Finally, at step 128, process 120 may then project the marker at the smoothed location and loop back to step 122. In projecting the marker at the smoothed location, process 120 may simply aim highlighter 114 in a specified direction without feedback, or may adjust the direction of highlighter 114 until the marker is determined by detector 110 to be in the correct location when used with a suitable detector 110.

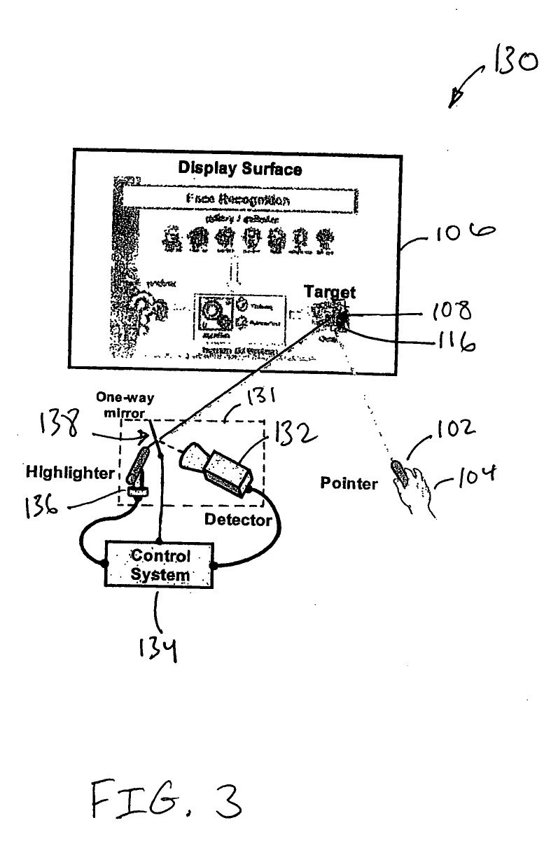

FIGS. 3-7 illustrate systems in accordance with alternate embodiments of the present invention.

As shown in FIG. 3, a system 130 may include a combined detector/highlighter 131. Combined detector/highlighter 131 includes a detector 132, a highlighter 136, and a controllable mirror 138. Using suitable geometry, controllable mirror 138 aims both detector 132 and highlighter 136 at the same point 108 on display surface 106. Mirror 138 may be any suitable mirror, prism, or other optical-mechanical device for aiming detector 132 and highlighter 136. Detector 132 is preferably a two-dimensional position sensitive detector (PSD), such as one of those available from Hamamatsu Corporation, Bridgewater, N.J., with an infrared filter, although a camera or any other suitable detection device may also be used. Highlighter 114 may be any suitable pointing device, such as laser pointer or other light source. As illustrated, detector 132, highlighter 136, and controllable mirror 138 are connected to a control system 134. Like control system 112, control system 134 determines the location of an illumination 116 on a surface 106 created by a pointer 102 held by the hand 104 of a user, filters out tremor detected in illumination 116, and aims a highlighter 136 at target point 108 to create a marker thereon. Control system 134 may be any suitable combination of hardware and/or software for determining the location of illumination 116 on surface 106, filtering out tremor detected in illumination 116, and aiming highlighter 136 at target point 108. Control system 134 may utilize a process similar to process 120 illustrated in FIG. 2.

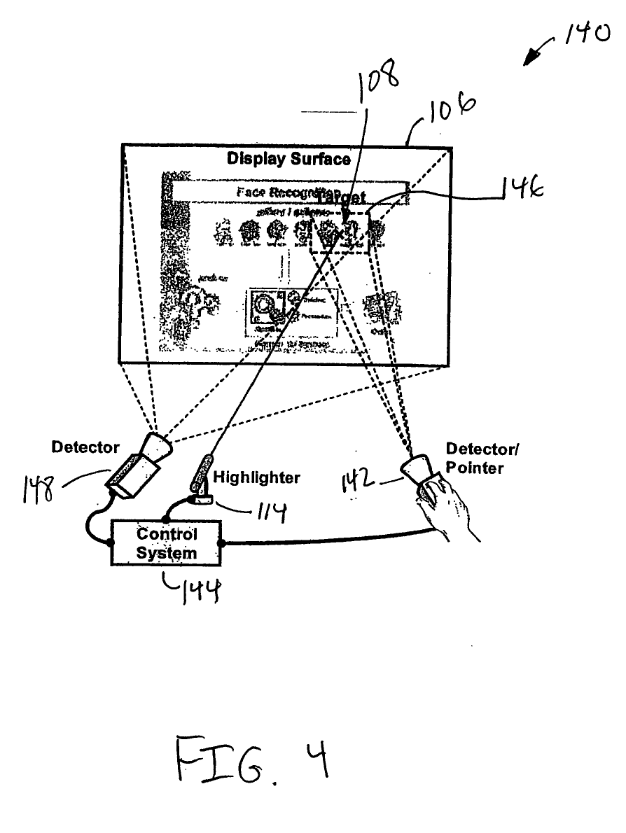

In system 140 illustrated in FIG. 4, the pointer directed by hand 104 of the user is a combination detector/pointer 142. Instead of illuminating a point on surface like pointer 102 in FIGS. 1 and 3, detector/pointer 142 detects features of an area 146 at or surrounding target point 108 in response to the user pointing detector/pointer 142 at surface 106. Preferably, detector/pointer 142 is a camera with a narrow field of view, although any suitable optical detector may be used. The features of area 146 may then be compared by control system 144 to the features of the entire area of surface 106 to determine the location of target point 108. Control system 144 may then aim highlighter 114 at target point 108 to create a marker thereon.

Detector 148 is preferably a camera with wide field of view for detecting the features over surface 106, although any suitable optical detector may be used. Control system 144 may be any suitable combination of hardware and/or software for determining the location of target point 108, filtering out detected tremor in the aiming of detector/pointer 142, and aiming highlighter 114 at target point 108. Control system 134 may utilize a process similar to process 120 illustrated in FIG. 2, except that the process determines the location of target point 108 by comparing the features detected by detector/pointer 104 and detector 148 instead of detecting illumination 116.

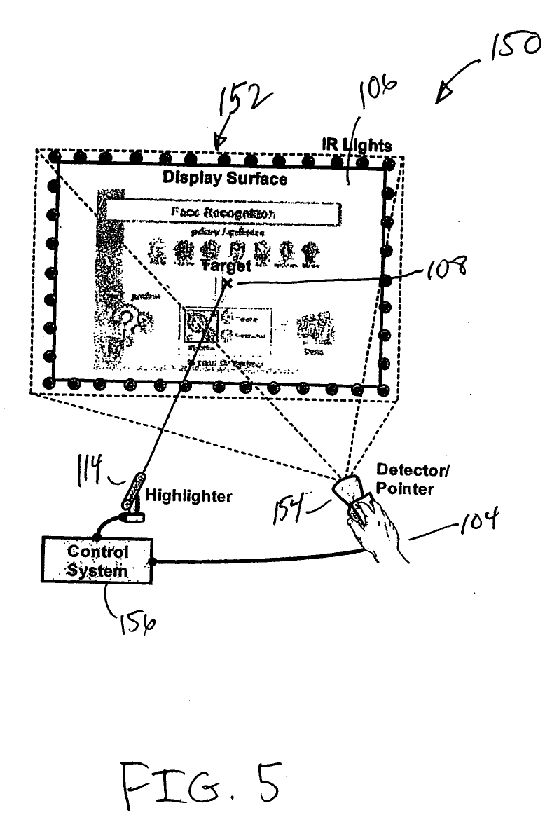

As illustrated in FIG. 5, a system 150 may be implemented with a single detector/pointer 154 rather than a detector/pointer 142 and a detector 148 as illustrated in FIG. 4. In such an implementation, a registration mechanism, such as infrared lights 152 may be placed around display surface 106. When detector/pointer 154 is directed at target point 108 by the user's hand 104, the detector/pointer may send information to control system 156 relating to the relative positions of lights 152. From this information, control system 156 may then determine the location of target point 108, filter out detected tremor in the aiming of detector point 154, and aim highlighter 114 at target point 108. Control system 156 may utilize a process similar to process 120 illustrated in FIG. 2, except that the process determines the location of target point 108 by detecting the relative positions of lights 152 instead of detecting illumination 116. Infrared lights 152 may be any suitable infrared light source.

Alternatively to using infrared lights 152 to detect the direction that detector/pointer 154 is pointing, a pattern could be projected on the screen by a presentation projector or any other suitable source. Preferably, the pattern would not be visible by viewers of the display surface. For example, the pattern could be projected in the infrared spectrum. Alternatively, the pattern could be projected for only some fraction, e.g., 10%, of each second. By detecting this pattern, the detector/pointer 154 may be used to determine the position in which the detector/pointer 154 is being pointed.

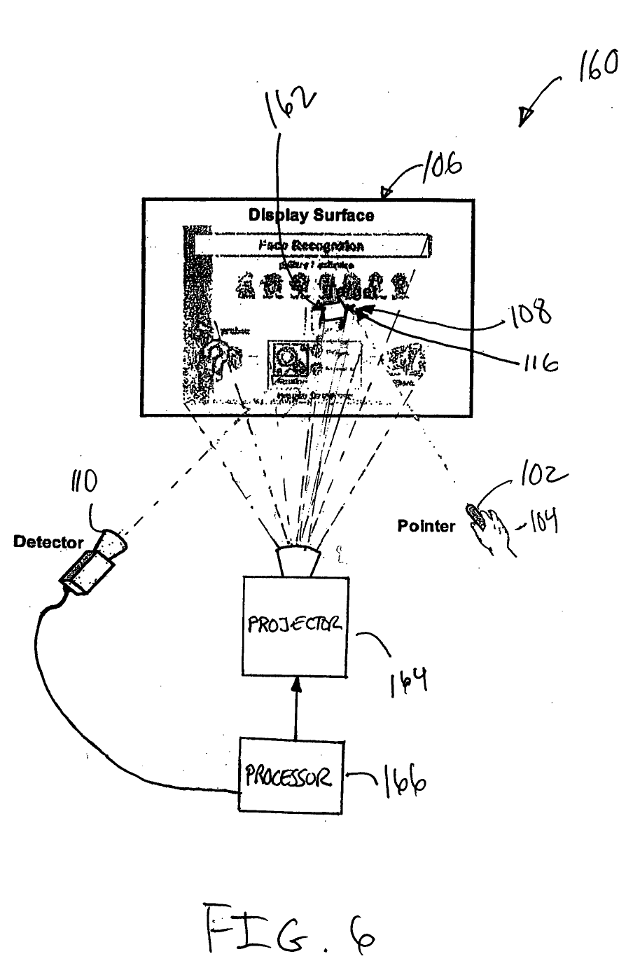

FIG. 6 illustrates a system 160 in accordance with one embodiment of the present invention in which the highlighter is a projector 164 that is used to present a marker 162 on surface 106 under the control of processor 166. Projector 164 may be any suitable projector for displaying a marker 162 on surface 106, and preferably includes the capabilities of known presentation projectors. Like control system 112 in FIG. 1, processor 166 determines the location of an illumination 116 on surface 106, filters out tremor detected in illumination 116, and controls the position of marker 162 so that it appears at target point 108. Processor 166 may be any suitable combination of hardware and/or software for determining the location of illumination 116 on surface 106, filtering out tremor detected in illumination 116, and controlling the position of marker 162 so that it appears at target point 108. In some embodiments of the invention, processor 166 may be part of projector 164. In some other embodiments, processor 166 may be part of a computer used to generate a presentation being displayed on surface 106 via projector 164. In yet other embodiments, processor 166 may be separate from both projector 164 and the computer being used to generate the presentation being displayed on surface 106. Processor 166 may utilize a process similar to process 120 illustrated in FIG. 2, except that the process controls the position of marker 162 by generating a video signal with the marker in the appropriate position or by sending appropriate control signals to projector 164, rather than aiming a highlighter 114.

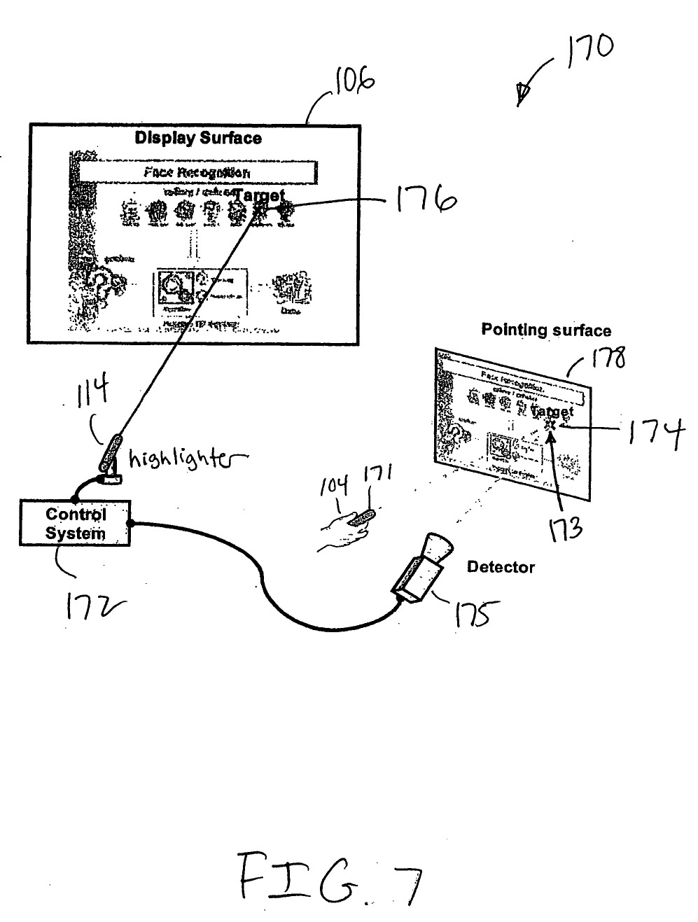

FIG. 7 illustrates a system 170 in accordance with one embodiment of the present invention in which the user's hand 104 may direct a pointer 171 at a pointing surface 178 that is different from a display surface 106 on which the tremor-cancelled marker is presented. This may be useful, for example, when the user is at a different location from display surface 106, when the user does not want to face surface 106 (e.g., when the user wants instead to face the audience), etc. Pointer 171 may be any suitable device for indicating a target point 174 on surface 178, and is preferably a visible laser pointer. Pointing surface 178 may be the screen of a laptop computer, a teleprompter, or any other suitable pointing surface. An illumination 173 on surface 178 caused by pointer 171 may then be detected by detector 175. Detector 175 may be any suitable detector for detecting illumination 173, and is preferably a PSD. Signals from detector 175 are provided to control system 172, which determines the location of illumination 173 on surface 178, filters out tremor detected in illumination 173, and aims a highlighter 114 at target point 176 on display surface 106 to create a marker thereon. Control system 172 may be any suitable combination of hardware and/or software for determining the location of illumination 173, filtering out tremor detected in illumination 173, and aiming highlighter 114 at target point 176. Control system 172 may utilize a process similar to process 120 illustrated in FIG. 2, except that the process detects the pointer illumination on pointing surface 178 rather than detecting the illumination on display surface 106.

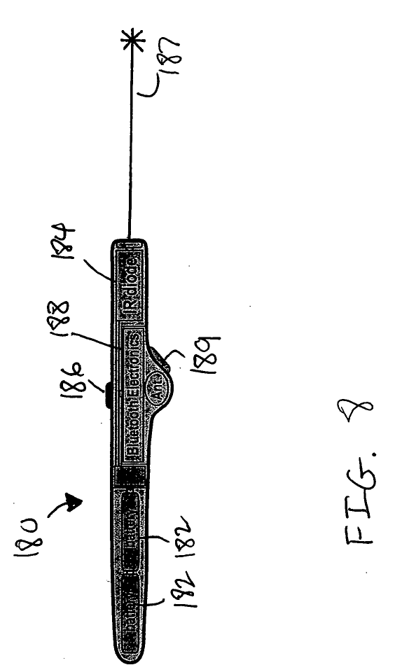

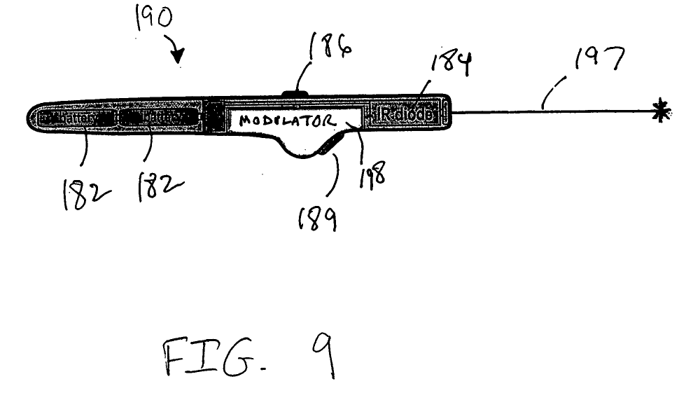

In some embodiments of the invention, it may be desirable to use the laser pointer as a mouse in connection with a computer application. By aiming the laser pointer at the display surface and determining the smoothed target position (i.e., the position of the marker), as described above, the position indicating aspects of a mouse can be provided. Because the smoothed target position is used, the reduced-tremor laser pointer has the added benefit that the mouse pointer can be precisely aimed. In order to facilitate the button clicks of a mouse, the laser pointer may include a button and transmit clicks of that button back to a computer running the computer application. Two examples of such lasers pointers are illustrated in FIGS. 8 and 9.

As shown in FIG. 8, a laser pointer 180 may include batteries 182, an infrared laser diode 184, a transmitter 188, and buttons 186 and 189. In one embodiment, using power from batteries 182, infrared laser diode generates a laser beam 187 when a user presses button 186. When the user presses button 189, the transmitter will transmit a signal indicating a “mouse click” that can then be received by a computer and interpreted accordingly. As illustrated in FIG. 8, laser diode 184 is an infrared light source, however, in alternate embodiments, such as that in FIG. 7, the light source may be in the visible spectrum. Transmitter 188 is illustrated in FIG. 8 as a Bluetooth transmitter, although any suitable transmitter technology may be used.

Rather than transmitting a separate signal in response to depressions of button 189, as described in connection with FIG. 8, a laser pointer 190 which modulates the laser beam 197 transmitted by diode 184 when button 189 is pressed may be used in accordance with one embodiment of the present invention. Then, the modulated laser beam may be detected by the detector used to detect the target point on the display surface, or any other suitable detector, and the “mouse click” signal passed to the appropriate computer. In such an embodiment, the detector should have a suitable bandwidth to detect the modulation of the laser beam.

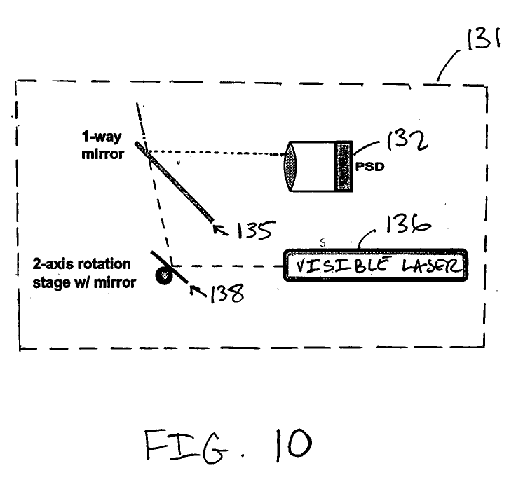

FIG. 10 illustrates in more detail the combined detector/highlighter illustrated in FIG. 3. As shown, combined detector/highlighter 131 includes a detector 132, a highlighter 136, a controllable mirror 138, and a one-way mirror 135. Detector 132 may be any suitable detector for detecting a given light source, such as a PSD. Highlighter 136 is preferably a visible laser source, although any suitable mechanism for creating a visible marker may be used. Controllable mirror 138 may be any suitable controllable optical-mechanical mechanism for pointing highlighter 136 at the desired spot on the display surface. As illustrated, this may be achieved using a two-axis rotation stage with mirror. One-way mirror 132 is preferably fixed and oriented so as to give detector 132 a wide field of view of the display surface. By arranging detector 132, highlighter 136, controllable mirror 138, and one-way mirror 135 in this way, combined detector/highlighter 131 can be made very compact.

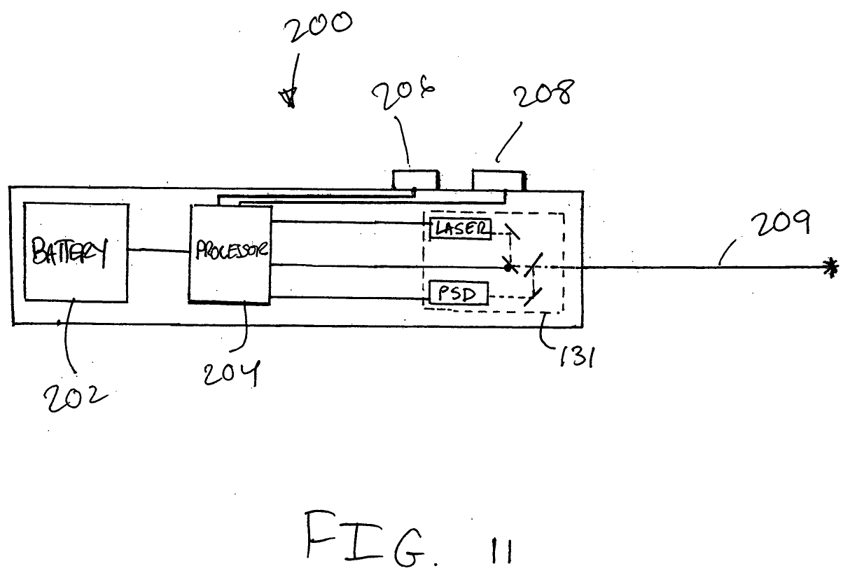

In one embodiment of the present invention that is illustrated in FIG. 11, a laser pointer with built-in tremor control may be implemented. As shown, laser pointer 200 includes a battery 202, a processor 204, a mouse button 206, a laser button 208, and a combined detector/highlighter 131. When a user presses button 208, processor 204, using power from batter 202, will activate the laser in combined detector/highlighter 131. The detector in combined detector/highlighter 131 may then detect the reflection of the laser beam on the display surface as well as other features of the display surface (e.g., such as letters in a presentation displayed on the display surface) and pass this information to processor 204. Using this information, processor 204 may then detect tremor in the reflected laser beam by comparing the position of the reflection to the other features, and control the controllable mirror in the combined detector/highlighter to minimize the reflected tremor. As described above, processor 204 may also modulate the laser in combined detector/highlighter 131 when mouse button 206 is depressed. Alternatively, a transmitter such as a Bluetooth transmitter, may be activated in response to mouse button 206 being depressed rather than modulating the laser.

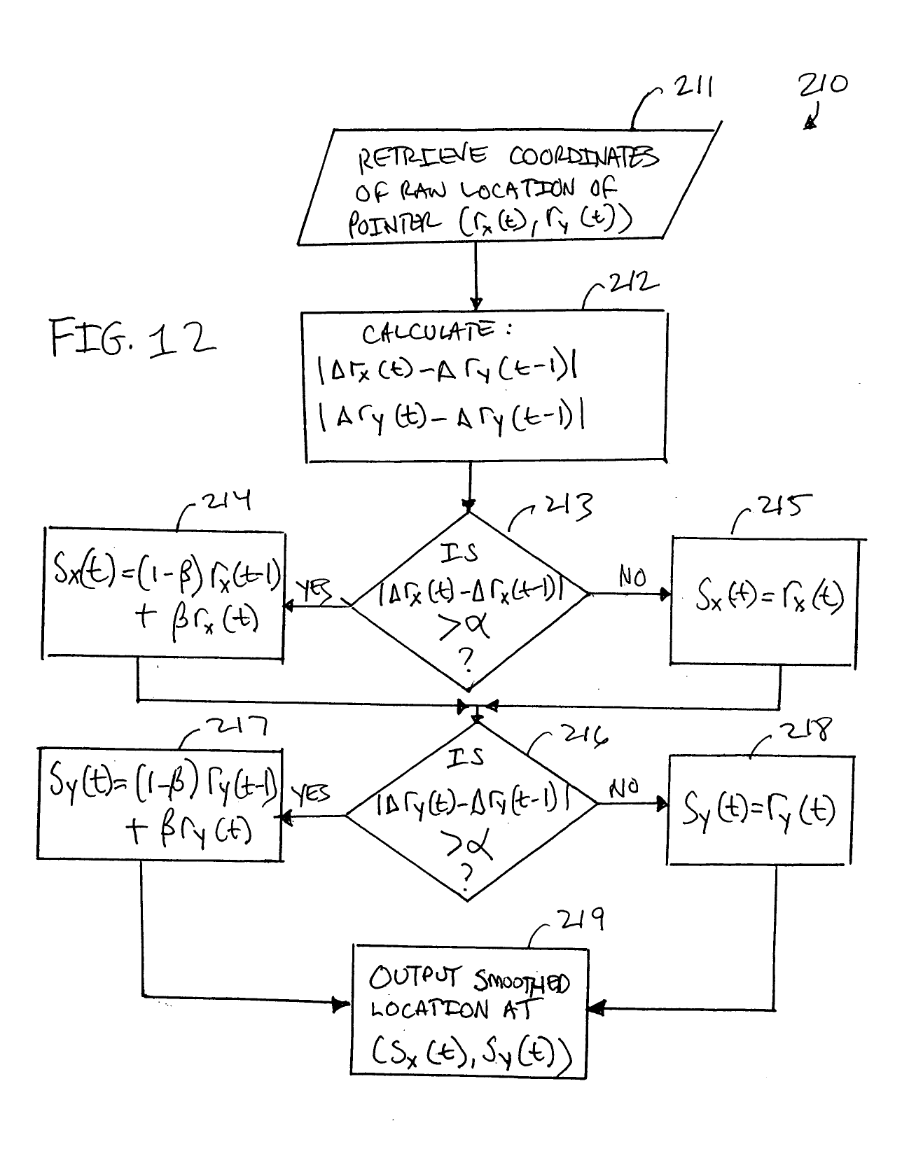

As stated above in connection with step 126 of FIG. 2, any of a number of known filtering techniques may be used to reduce tremor that is detected in the pointing of a pointing device by a user. For example, a band pass filter process 210 may be used to block the high frequency movements that are characteristic of tremors as shown in FIG. 12. As illustrated, at step 211, process 210 retrieves the coordinates rₓ(t) and r_{y}(t) of the raw position of the pointer. Next, at step 212, the process calculates |Δrₓ(t)−Δrₓ(t−1)| and |Δr_{y}(t)−Δr_{y}(t−1)|, where Δr(t)=r(t)−r(t−1). If it is determined that |Δrₓ(t)−Δrₓ(t−1)| is greater than α, the frequency pass variable, at step 213, then the smoothed position x-axis coordinate, sₓ(t), is set equal to (1−β)rₓ(t−1)+βrₓ(t), where β is the variable determining how much of the high frequency movement is retained, at step 214. Otherwise, sₓ(t) is set equal to rₓ(t) at step 215. Following steps 214 and 215, at step 216, process 210 determines whether |Δr_{y}(t)−Δr_{y}(t−1)| is greater than α. If so, the smoothed position y-axis coordinate, s_{y}(t), is set equal to 1−β)r_{y}(t−1)+βr_{y}(t) at step 217. Otherwise, s_{y}(t) is set equal to r_{y}(t) at step 218. Finally, at step 219, the smoothed position coordinates, sₓ(t) and s_{y}(t), are output from process 210.

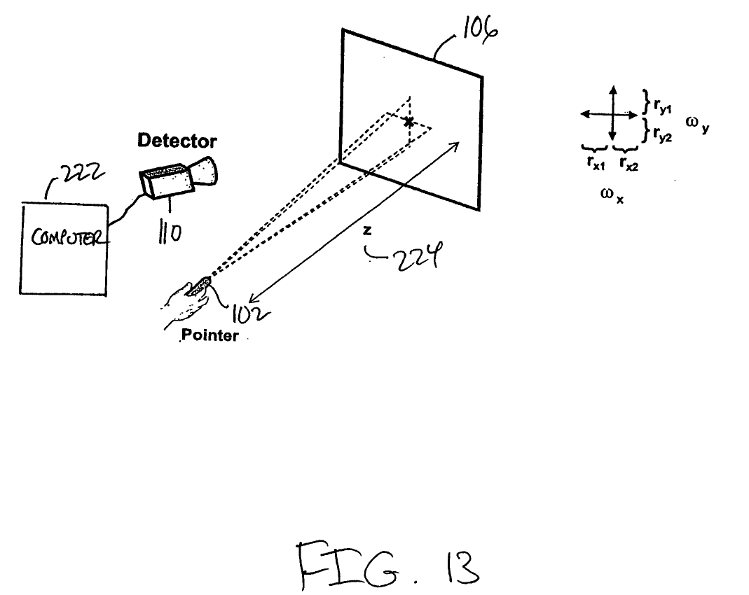

The value of α used in process 210 may be determined using any suitable technique. One approach is to determine this variable from the setup routine illustrated in FIG. 13. As shown, a user may be asked to aim a pointer 102 at a display surface 106 from at least some distance z, 224, and hold the pointer steady. A detector 110 and a computer 222 may then be used to detect and measure tremor in the movements of the illumination on surface 106 from pointer 102. The computer may assign to a the least, greatest, or average, or some percentage thereof, of |Δrₓ(t)−Δr_{y}(t−1)| and |Δr_{y}(t)−Δr_{y}(t−1)| over the setup period. The distance z, 224, may be selected based upon the resolution of detector 100, and the distance of detector 10 to surface 106. If desired, α may then be modified by a user to fine tune the level of filtering being performed. Alternatively to performing the setup routine described above, in some embodiments, α may be assigned a predetermined value that may then be adjusted by the user, if desired.

Any suitable value between 0 and 1 may be used for β. For example, β may be initially set to 0.5 and then adjusted when desired by the user.

Filtering in accordance with the present invention may also be accomplished using Kalman filters. In a preferred embodiment, a six state linear model is used wherein the state z is z=(x, y, vₓ, v_{y}, aₓ, a_{y}), and x and y represent a location of the pointer on the display surface, vₓ and v_{y} represent a velocity of the pointer on the display surface, and aₓ and a_{y} represent an acceleration of the pointer on the display surface. By incorporating tremor as process noise w, the predicted value can account for it and eliminate it. The basic system definition is:

z(t)=Az(t−1)+w (1)

y(t)=Bz(t−1)+e (2)

wherein: z(t) is the predicted state;

y(t) is the measured signal;

A is the state transition matrix;

B is a matrix which states which parameters are measurable;

w is the process noise (i.e., hand tremor); and

e is the measurement noise (i.e., detector noise).

Once a measurement is made of a predicted value, the next estimate is changed to account for the error in the previous prediction, e(t)=y(t)−Bz(t). Given an accurate state space model of the hand and laser pointer movement, the Kalman filter can estimate the smoothed position at which to show the visible pointer at time t such that it closely matches raw position of the invisible laser pointer while using the process noise w to tweak how the tremor is attenuated by the system.

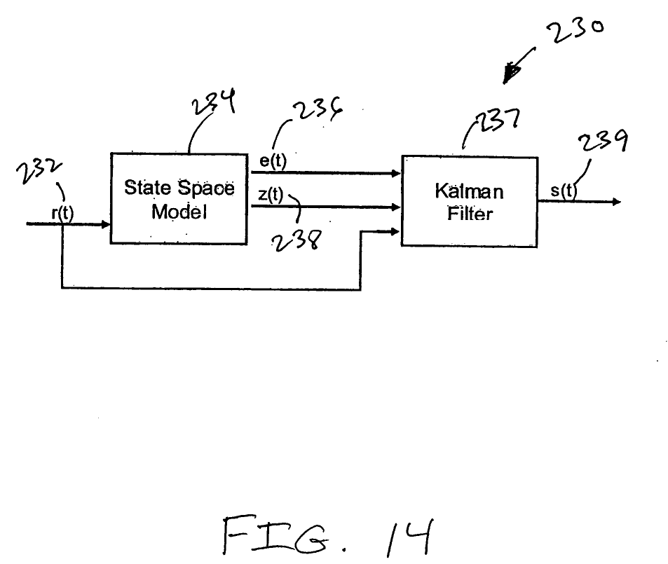

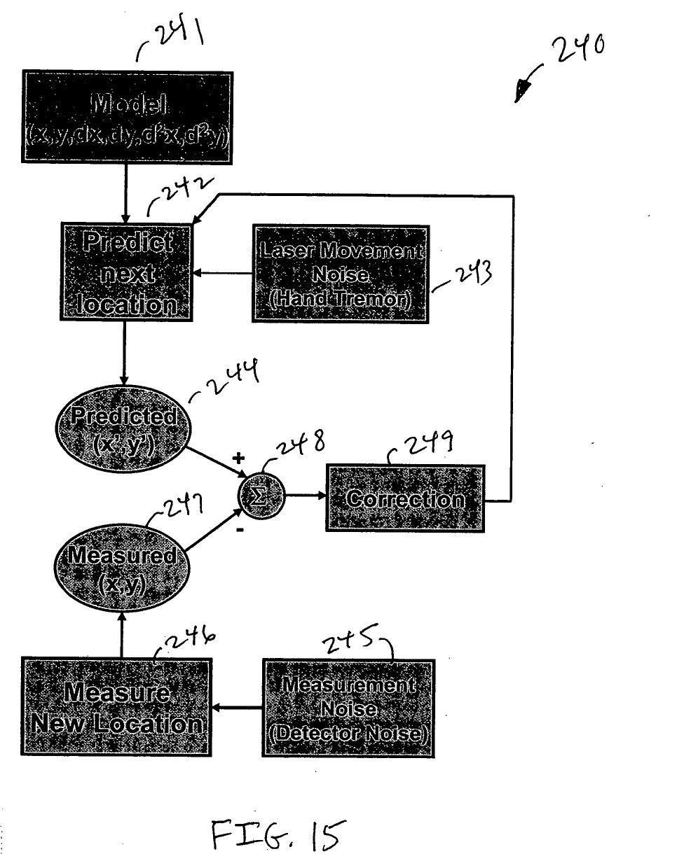

The signal flow of the Kalman filter is illustrated in FIGS. 14 and 15. As shown in FIG. 14, raw position data, r(t) 232, is input into the state space model block 234. The detector noise, e(t) 236, and the predicted state, z(t) 238, are provided from state space model block 234 to the Kalman filter block 237 along with the raw position data. Kalman filter block 237 outputs the smoothed position data, s(t) 239.

FIG. 15 shows this process in more detail. As illustrated in process 240, the state space model 241, the hand tremor measurements 243, and a correction value 249 are used to predict the next smoothed location 244 of the pointer at step 242. The new raw location 247, taking into account detector noise 245, is measured at step 246. The new raw location 247 is compared to the predicted smoothed location 244 to provide a correction value 249. This correction value 249 is then provided to step 242 to predict the next smoothed location 244. In this way, the Kalman filter adaptively adjusts to changes in tremor and detector noise, while filtering out tremor and allowing for intentional movement of the pointer.

A linear equalization filter may also be used in accordance with the present invention. The smoothed position value can be represented as:

$$s ( t ) = {\sum }_{i = 1}^{M} {w}_{i} r ( t - i ) = {w}^{T} r ( t ) \qquad ( 3 )$$

wherein: r(t) is the raw position value;

M is the number of previous data points used in the filter; and

w is the vector used to minimize a Filtered Mean Square Error with delay correction (F-MSE_{d}(w)).

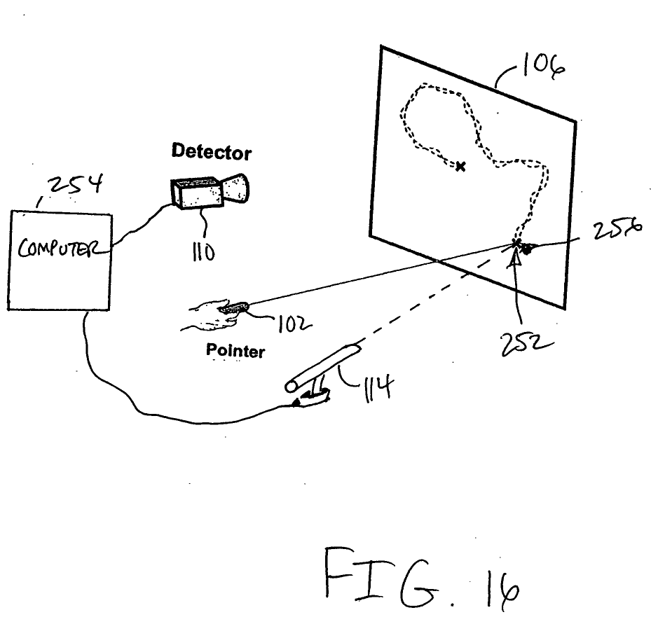

In order to determine the optimal tremor correcting vector w, a tracking training process may be performed as illustrated in FIG. 16. As shown, a marker 252 created by a highlighter 114 under the control of a computer 254 is moved around a display surface 106. A user then follows marker 252 around the surface using a pointer 102. An illumination 256 from the pointer is detected by a detector 110 and provided to computer 254. Computer 254 the uses any suitable optimization technique to find the optimal tremor correcting vector w that minimizes F-MSE_{d}(w).

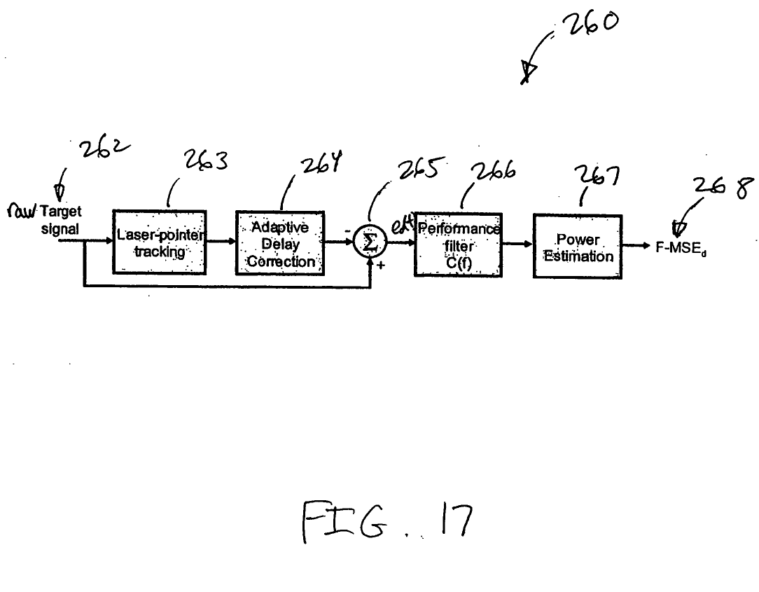

FIG. 17 shows a flow 260 that may be used by computer 254 to calculate the F-MSE_{d}(w), and thus to find the best vector w. As illustrated, after tracking a raw target signal 262 at block 263, the delay in the resulting tracking signal is corrected to closely match the raw target signal 262 being displayed on display surface 106. This may be done using an adaptive delay estimation algorithm 264. The output of adaptive delay estimation algorithm 264 is then compared with raw target signal 262 to provide a delay correction error e_{d}(t). This value for e_{d}(t) is then filtered by block 266 to enhance the desired frequencies using a differentiator. Finally, at block 267 the actual value of F-MSE_{d} is calculated. The F-MSE_{d} of a vector w is:

F-MSE_{d}(w)=E[e_{d}(t)*c(t)]² (4)

wherein: E=statistical expectation;

*=convolution operator; and

c(t)=impulse response of the performance filter.

Once the optimal vector w has been identified, the linear equalization filter in equation (3) may then be used to find the smoothed position values, s(t), from the raw position values, r(t).

Because the linear equalization filter works best on the type of tremor it was trained on, different filters may need to be created for different types of people and conditions, such as different age groups, medical conditions, and distances from the display surface. This may be accomplished by repeating the tracking training process described above for these different types of people and conditions, and then enabling a user of the invention to select the appropriate filter when tremor reduction is desired.

Yet another filter that may be used in accordance with embodiments of the present invention in which tremor control is built into a laser pointer, such as that illustrated in FIG. 11, is the Weighted Fourier Linear Combiner filter. Using this filter, hand tremor is modeled as a quasi-periodic signal by adapting the frequency, amplitude, and phase of a reference signal generated artificially by a dynamic truncated Fourier series model:

$$y ( t ) = {\sum }_{n = 1}^{M} [ {w}_{{n}_{t}} {a}_{r} sin ( n {w}_{{0}_{t}} t ) + {w}_{( n + M t )} {b}_{r} cos ( n {w}_{{0}_{t}} k ) ] \qquad ( 5 )$$

wherein: yₖ=computed periodic signal estimating tremor

Wᵣ_{ₖ}=frequency coefficient of the model

aᵣ, bᵣ=amplitude coefficients of the model

k=phase coefficient of the model

The model is used to provide zero-phase attenuation of hand tremors by anticipating and subtracting the tremor from the input signal such that the smoothed position values, s(t), is just the raw position values, r(t), with the computed noise estimate, y(t), subtracted from it, as represented by the following equation:

s(t)=r(t)−y(t) (6)

Using any suitable least mean squares approach and the raw position values, the coefficients in equation (5) can then be adjusted to improve the performance of the filter.

In some embodiments of the invention, more than one filter may be used simultaneously. For example, a band pass filter may be used to reduce high frequency tremors while a Kalman filter may be used to reduce low frequency tremors.

Persons skilled in the art will thus appreciate that the present invention can be practiced by other than the described embodiments, which are presented for purposes of illustration and not of limitation, and that the present invention is limited only by the claims that follow.

What is claimed is:

1. A system for canceling pointer tremor of a user, comprising:
a detector that generates raw position signals representative of positions on a pointing surface pointed to by the user;
a control system coupled to the detector that receives the raw position signals from the detector, that filters motion detected in the raw position signals to produce smoothed position signals, and that produces a control signal representative of the position of the smoothed position signals; and
a highlighter coupled to the control system that receives the control signal and that causes a marker to be presented on a display surface in response to the control signal.

2. The system of claim 1, wherein the pointing surface is the same surface as the display surface.

3. The system of claim 1, wherein the pointing surface is a different surface than the display surface.

4. The system of claim 1, further comprising a pointer that may be used by the user to point to the positions on the display surface.

5. The system of claim 4, wherein the pointer comprises a laser pointer.

6. The system of claim 5, wherein the laser pointer comprises an infrared laser.

7. The system of claim 5, wherein the laser pointer comprises a visible laser.

8. The system of claim 1, wherein the pointer has detection capabilities.

9. The system of claim 8, wherein the pointer comprises a position sensitive detector.

10. The system of claim 8, wherein the pointer comprises a camera.

11. The system of claim 8, wherein the pointer detects features of the display surface, and wherein the control system compares features detected by the pointer to features detected by the detector.

12. The system of claim 4, wherein the pointer further comprises a mouse button.

13. The system of claim 12, wherein the pointer further comprises a transmitter and wherein the mouse button is coupled to a transmitter.

14. The system of claim 13, wherein the transmitter is a Bluetooth transmitter.

15. The system of claim 12, wherein the pointer further comprises a modulator and wherein the mouse button is coupled to the modulator.

16. The system of claim 1, further comprising a registration mechanism.

17. The system of claim 16, wherein the registration mechanism is infrared lights positioned around the display surface, and the detector detects a relative position of the infrared lights.

18. The system of claim 16, wherein the registration mechanism is a pattern that is projected on the display surface, and the detector detects the pattern.

19. The system of claim 1, wherein the detector is a position sensitive detector.

20. The system of claim 1, wherein the detector is a camera.

21. The system of claim 1, wherein the highlighter is a visible laser.

22. The system of claim 1, wherein the highlighter is a presentation projector.

23. The system of claim 22, wherein the presentation projector projects a marker symbol.

24. The system of claim 22, wherein the presentation projector comprises a laser.

25. The system of claim 1, wherein the highlighter comprises a mirror that may be moved on a two-axis gimbal.

26. The system of claim 1, wherein the highlighter may be aimed by the control system.

27. The system of claim 1, wherein the detector and the highlighter are part of a combined detector/highlighter.

28. The system of claim 1, wherein the control system is part of a presentation projector.

29. The system of claim 1, wherein the control system is a computer being used to generate a presentation.

30. The system of claim 1, wherein the control system performs a band pass filter process.

31. The system of claim 1, wherein the control system performs a Kalman filter process.

32. The system of claim 1, wherein the control system performs a linear equalization function process.

33. A laser pointer comprising:
a laser source that generates a laser beam;
a detector that detects a reflection of the laser beam and at least one other feature of a display surface;
a controllable mirror that controls a direction in which the laser source and the detector are pointing;
a processor that detects motion in the reflection relative to the at least one other feature, that filters the motion, and that controls the controllable mirror to reduce tremor in the laser beam.

34. The laser pointer of claim 33, wherein the processor performs a weighted Fourier linear combiner filter process.

35. A method for canceling pointer tremor of a user, comprising the steps of:
detecting raw positions on a pointing surface pointed to by the user;
filtering motion detected in the raw positions to produce smoothed positions; and
causing a marker to be presented on a display surface at the smoothed positions.

36. The method of claim 35, wherein the pointing surface is the same surface as the display surface.

37. The method of claim 35, wherein the pointing surface is a different surface from the display surface.

38. The method of claim 35, wherein the step of detecting raw positions on the pointing surface comprises detecting first features of the pointing surface near a position pointed to by the user, detecting second features of substantially all of the pointing surface, and comparing the first features and the second features to determine where the user is pointing.

39. The method of claim 35, wherein the step of detecting raw positions on the display surface comprises detecting a relative position of infrared lights surrounding the pointing surface.

40. The method of claim 35, wherein the step of detecting raw positions on the pointing surface comprises detecting a pattern projected on the pointing surface.

41. The method of claim 35, wherein the step of filtering comprises using a band pass filter process.

42. The method of claim 35, wherein the step of filtering comprises using a Kalman filter process.

43. The method of claim 35, wherein the step of filtering comprises using a linear equalization function process.

44. A system for canceling pointer tremor of a user, comprising:
a means for detecting raw positions on a pointing surface pointed to by the user;
a means for filtering motion detected in the raw positions to produce smoothed positions; and
a means for causing a marker to be presented on a display surface at the smoothed positions.

45. The system of claim 44, wherein the pointing surface is the same surface as the display surface.

46. The system of claim 44, wherein the pointing surface is a different surface from the display surface.

47. The system of claim 44, wherein the means for detecting raw positions on the pointing surface detects first features of the pointing surface near a position pointed to by the user, detects second features of substantially all of the pointing surface, and compares the first features and the second features to determine where the user is pointing.

48. The system of claim 44, wherein the means for detecting raw positions on the display surface detects a relative position of infrared lights surrounding the pointing surface.

49. The system of claim 44, wherein the means for detecting raw positions on the pointing surface detects a pattern projected on the pointing surface.

50. The system of claim 44, wherein the means for filtering uses a band pass filter process.

51. The system of claim 44, wherein the means for filtering uses a Kalman filter process.

52. The system of claim 44, wherein the means for filtering uses a linear equalization function process.
